(19) United States
(12) Patent Application Publication
(10) Pub. No.: US 2008/0023306 A1
(43) Pub. Date: Jan. 31, 2008

(54) Timer for use with vehicle's 12-volt power socket

(76) Inventors: Michael Jodoin, Stockton Springs, ME (US); George P. George, Stockton Springs, ME (US)

Correspondence Address: JAMES RAY & ASSOCIATES, 2640 PITCAIRN ROAD, MONROEVILLE, PA, 15146, US

(21) Appl. No.: 11/880,835

(22) Filed: Jul. 24, 2007

Related U.S. Application Data
(60) Provisional application No. 60/833,040, filed on Jul. 25, 2006.

(51) Int. Cl. H01H 7/08

(52) U.S. Cl. 200/35 R

(57) ABSTRACT

The present invention provides an electrical appliance timer for use with a 12-Volt power socket mounted within a vehicle and coupled to a vehicle's battery. The timer includes a housing having each of a predetermined size and a predetermined shape and a timing circuit which is mounted within the housing. An electrical receptacle is also mounted within the housing and is operatively coupled to the timing circuit for operatively receiving a plug of the appliance and there is a plug which is operatively coupled to the timing circuit for operative engagement with the 12-Volt power socket. A user interface is operatively coupled to the timing circuit and is operable from an exterior surface of the housing, whereby the timing circuit is responsive to the user interface for selectively supplying and terminating supply of 12-Volt power from the plug to the receptacle.

### CROSS-REFERENCE TO RELATED APPLICATIONS

This application is related to and claims priority from Provisional Patent Application Ser. No. 60/833,040 filed Jul. 25, 2006.

### FIELD OF THE INVENTION

The present invention relates, in general, to electrical timers and, more particularly, this invention relates to an electrical timer for use with a 12-Volt power socket of a vehicle.

### BACKGROUND OF THE INVENTION

As is generally well known, long haul truck operators do not always have capability to power electrical appliances, for example such as coffee makers or hot plates, while driving or resting and enjoy hot foods or drinks in the comfort of the truck's cab. Since the truck operator often sleep or rest in the cab of the truck parked alongside the road they must spend valuable time to drive to the nearest restaurant in order to obtain hot foods or drinks. Similar difficulty is experienced by campers setting up camp in close proximity to a vehicle. The presently available appliances that operate from a 12-Volt power supply cannot be connected to a standard 12-Volt power socket of the passenger automobile or truck.

### SUMMARY OF THE INVENTION

The invention provides an electrical timer for use with a 12-Volt power socket mounted within a vehicle and coupled to a vehicle's battery. The timer includes a housing. The housing has a predetermined size and a predetermined shape and a timing circuit which is mounted within the housing. An electrical receptacle is also mounted within the housing and is operatively coupled to the timing circuit for operatively receiving a plug of the appliance and there is a plug which is operatively coupled to the timing circuit for operative engagement with the 12-Volt power socket. A user interface is operatively coupled to the timing circuit and is operable from an exterior surface of the housing, whereby the timing circuit is responsive to the user interface for selectively supplying and terminating supply of 12-Volt power from the plug to the receptacle.

### OBJECTS OF THE INVENTION

It is, therefore, one of the primary objects of the present invention to provide a timer for use with a 12-Volt power socket of a vehicle.

Another object of the present invention is to provide a timer for use with a 12-Volt power socket of a vehicle which can control operation of 12-Volt powered appliances.

Yet another object of the present invention is to provide a timer for use with a 12-Volt power socket of a vehicle which includes display and a manually operable selector controls.

A further object of the present invention is to provide a timer for use with a 12-Volt power socket of a vehicle which includes a power socket for charging a cell phone or other handheld electronic device.

Yet a further object of the present invention is to provide a timer for use with a 12-Volt power socket of a vehicle which is simple to use.

Another object of the present invention is to provide a timer for use with a 12-Volt power socket of a vehicle which includes a clock.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of an electrical timer for use with a 12-Volt power socket of a vehicle;

FIG. 2 is a side elevation view of the timer of FIG. 1;

FIG. 3 is a diagram view of the timer of FIG. 1; and

FIG. 4 is a perspective view of the timer of FIG. 1 in combination with the vehicle's cab which is partially illustrated.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

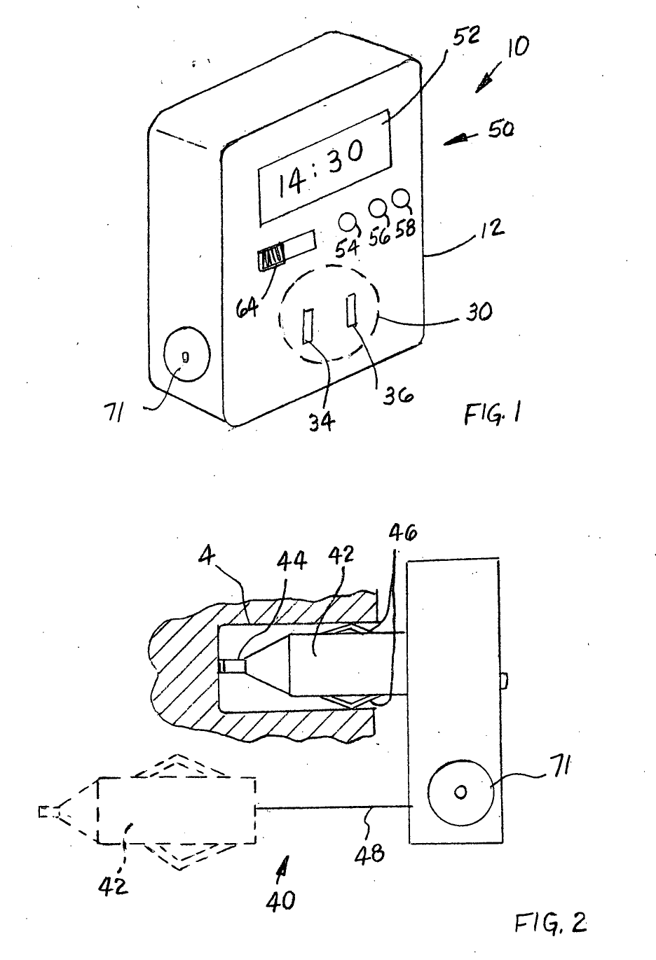

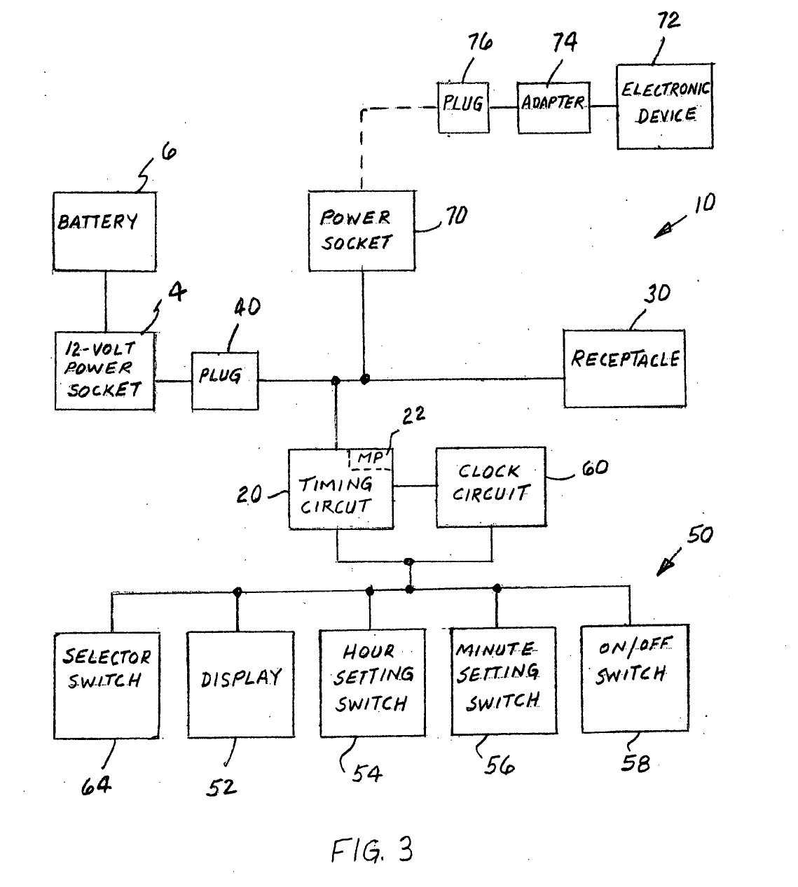

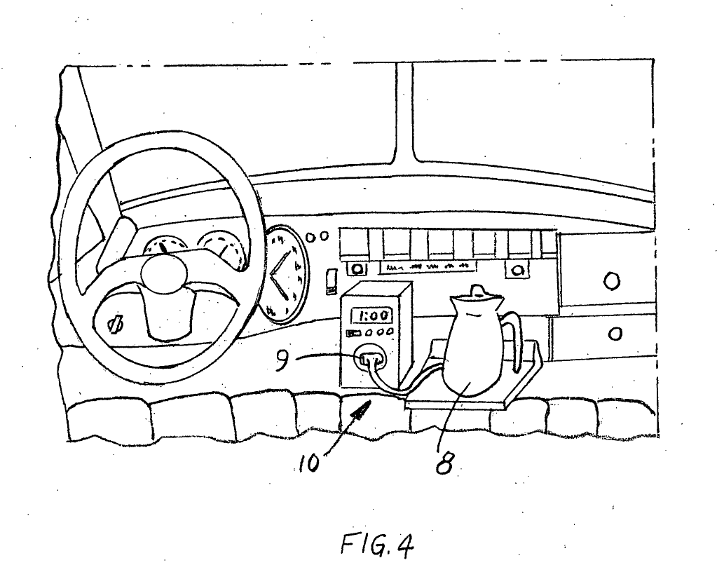

Reference is now made, to FIGS. 1-4, wherein there is shown an electrical timer, generally designated as 10, which is used in combination with a 12-Volt power socket 4, such as a well known cigarette lighter socket, mounted within a vehicle 2 and which is coupled to a vehicle's battery source 6 for selectively turning on and off at least one appliance 8.

The timer 10 includes a hollow housing 12 having each of a predetermined size and a predetermined shape. The presently preferred shape of the housing 12 is a parallelepiped measuring about 4 inches in width by about 6 inches in height and about 2 inches in depth. Mounted within the hollow housing 12 is a timing circuit 20 which preferably includes a microprocessor device 22 for controlling operation of the timer 10.

An electrical receptacle 30 is mounted within the housing 12 and is operatively coupled to the timing circuit 20 for operatively receiving a plug 9 of such at least one appliance 8. Accordingly, the receptacle 30 has first elongated aperture 34 and a second elongated aperture 46 which are formed in a conventional manner within the wall of the housing 12.

There is a plug means 40 which is operatively coupled to the timing circuit 20 for operative engagement with the 12-Volt power socket 4. The plug means 40 includes an elongated plug body 42. In a conventional arrangement, a positive electrical contact 44 is disposed on the first end of the elongated plug body 42 for engaging the complimentary positive contact of the 12-Volt power socket 4 and the negative electrical contacts 46 are disposed on the surface of the elongated plug body 42 for engaging the complimentary negative electrical contacts of the 12-Volt power socket 4.

The distal end of the plug means 40 may be disposed on and secured to the housing 12 wherein the elongated plug body 42 extends outwardly from the surface of the housing 12 and, preferably, the plug means 40 includes a flexible cord 48 having a predetermined length for operably connecting the plug means 40 to the housing 12 and, more particularly to the receptacle 30, as best shown in FIG. 2. The length of the flexible cord 38 is determined based on the particular application of the timer 10. By way of an example only, a camper may desire to position the appliance 8 in close proximity to the camping location and away from the vehicle 2. The truck operator may desire to position appliance toward the rear of the cab and may need a shorter flexible cable 48.

There is also a user interface, generally designated as 50, which is operatively coupled to the timing circuit 20 and which is operable from an exterior surface of the housing 12. It will be appreciated that the timing circuit 20 is responsive to the user interface 50 for selectively supplying and terminating supply of 12-Volt power from the plug means 40 to the receptacle 30. The user interface 50 includes a display 52, which is preferably of a Liquid Crystal Display (LCD) type and various control elements. A first control element is a manually operable switch means 54 which is provided for selecting and setting hours while a second control element being a switch means 56 is provided for selecting and setting minutes. There is also a manually operable switch means 58 which is provided for manually initiating supply of 12-Volt power and terminating the supply of 12-Volt power from the plug means 40 to the receptacle 30. In the presently preferred embodiment of the invention the switch means 54, 56 and 58 are of a pushbutton type.

The present invention contemplates for the timer 10 to include a clock circuit 60 for generating and displaying the time on the user interface 50 and, more particularly on the display 52. The clock circuit 60 may be constructed in accordance with any presently used digital or electronic type clocks. Accordingly, a selector switch means 64, preferably of a slider type, is provided for switching operation of the display 52 between setting and displaying chronological time and setting timing circuit 20 and displaying elapsed timer time. To improve viewing of the time, the display 52 employs back light (not shown).

It is also within the scope of the present invention to provide a 12-Volt power socket 70 which is disposed within the hollow housing 12 and which is substantially identical to the 12-Volt power socket 4 of the vehicle 2 for receiving a plug 76 of a charging adapter 74 for use in combination with a hand held electronic device 72, for example such as a mobile phone. Accordingly, an aperture 71 is formed within the wall portion of the housing 12 for enabling access to the 12-Volt power socket 70. Thus the timer 10 can remain plugged into the 12-Volt power socket 4 while the user charges the electronic device 72.

In use, to control operation of the appliance 8, the user inserts the plug means 40 into the power socket 4 and simply slides the selector switch means 64 to one side which is associated with the operation of the timing circuit 20 and uses the switch means 54 and 56 to set a desired duration in hours and/or minutes respectively. The timing circuit 20 is then activated to supply 12-Volt power from the plug means 40 to the receptacle 30 and further to the appliance 8. When the preset time duration has elapsed the timing circuit 20 discontinues supply of the 12-Volt power to the receptacle 30 or the user may operate the switch means 58 for at least manually terminating the supply of 12-Volt power from the plug means 40 to the receptacle 30.

When the user desires to set or display chronological time the user slides the selector switch means 64 to the opposite side to display the time and, when required, uses the switch means 54 and 56 to set or reset displayed time in hours and/or minutes respectively.

Advantageously, the user interface 50 is employed to set a specific timer activation time either prior or after setting the timer duration. Thus, the user can set the timer 10 prior to resting and have a prepared drink or food upon waking up.

Although the present invention has been shown in terms of having only one receptacle 30, it will be apparent to those skilled in the art, that the present invention may be constructed to include more than one receptacle 30 wherein the timing circuit 20 and the user interface 50 will be adapted to operably control such plurality of receptacles 30.

Furthermore, any conventional type and arrangement of the timing circuit 20 can be employed in the present invention.

Additionally, it is within the scope of the present invention to employ other shapes and sizes of the housing 12 Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. In combination with a 12-Volt power socket mounted within a vehicle and coupled to a vehicle's battery, an electrical timer for selectively turning on and off at least one appliance, said timer comprising:
(a) a housing having each of a predetermined size and a predetermined shape;
(b) a timing circuit which is mounted within said housing;
(c) at least one electrical receptacle which is mounted within said housing and is operatively coupled to said timing circuit for operatively receiving a plug of such at least one appliance;
(d) a plug means which is operatively coupled to said timing circuit for operative engagement with said 12-Volt power socket; and
(e) a user interface which is operatively coupled to said timing circuit and which is operable from an exterior surface of said housing, whereby said timing circuit is responsive to said user interface for selectively supplying and terminating supply of 12-Volt power from said plug means to said at least one receptacle.

2. The timer, according to claim 1, wherein said timing means includes a microprocessor device for controlling operation of said timer.

3. The timer, according to claim 1, wherein said plug means is disposed on and secured to said housing and extends outwardly therefrom.

4. The timer, according to claim 1, wherein said timer includes a flexible cord having a predetermined length for operably connecting said plug means to said housing and to said timing circuit.

5. The timer, according to claim 1, wherein said user interface includes a display and timer control elements.

6. The timer, according to claim 5, wherein said display is a Liquid Crystal Display (LCD).

7. The timer, according to claim 5, wherein said timer control elements includes a first manually operable switch means for selecting and setting hours and a second switch means for selecting and setting minutes.

8. The timer, according to claim 5, wherein said timer control elements includes a manually operable switch means for manually initiating supply of 12-Volt power and terminating said supply of 12-Volt power from said plug means to said at least one receptacle.

9. The timer, according to claim 1, wherein said timer includes a clock means for generating and displaying chronological time on said user interface.

10. The timer, according to claim 9, wherein said timer further includes a selector switch means for switching operation of said user interface between setting and displaying chronological time and setting timer duration and displaying elapsed time.

11. The timer, according to claim 1, wherein said timer includes a 12-Volt power socket which is disposed within said hollow housing and which is substantially identical to said 12-Volt power socket of said vehicle for receiving a plug of a charging adapter for use in combination with an electronic device, and wherein an aperture is formed within a wall portion of said housing in alignment with said 12-Volt power socket disposed within said housing.
